(19) United States
(12) Patent Application Publication
(10) Pub. No.: US 2009/0095830 A1
(43) Pub. Date: Apr. 16, 2009

(54) Shredder waste management system

(76) Inventor: Simon Huang, Taipei (TW)

Correspondence Address: Venable, 2049 Century Park East, 21st Floor, LOS ANGELES, CA, 90067, US

(21) Appl. No.: 12/148,209

(22) Filed: Apr. 17, 2008

Related U.S. Application Data
(63) Continuation-in-part of application No. 11/974,564, filed on Oct. 15, 2007.

(51) Int. Cl. B02C 23/00

(52) U.S. Cl. 241/100

(57) ABSTRACT

The present invention relates generally to shredder waste management systems. Specifically, this invention discloses a shredder waste management system with a universal shredder waste bag that can be used in various sized shredders. In addition, this invention discloses various mechanisms for securing a shredder waste bag in a shredder.

### CLAIM OF PRIORITY

This application is a continuation-in-part application to U.S. Ser. No. 11/974,564 which was filed on Oct. 15, 2007.

### BACKGROUND OF THE INVENTION

1. Field of the Invention

The present invention relates generally to shredder waste management systems. Specifically, this invention discloses a universal shredder waste bag that can be used in various sized shredders. In addition, this invention discloses various mechanisms for securing a shredder waste bag in a shredder.

2. Background Information

With increased privacy concerns, shredders have become an integral part in both homes and businesses. Though originally used to destroy paper products, shredders are now used to shred other forms of media that hold information, such as compact discs. In addition, credit cards and other plastic products are commonly shredded.

Conventional shredders have a waste basket or base for collecting material that is shredded. In order to dispose of the shredded material, either the entire base has to be carried to a trash bin, or the contents of the base have to be transferred to a bag, which is then carried to a trash bin. Any person who has transferred shredded material from a shredder base to a bag is well aware of the mess that oftentimes occurs during the transfer.

Since current shredders do not have a mechanism for securing a waste bag, some users may try to secure a waste bag by lodging it between the base and the housing. In order to ensure secureness, a significant portion of the waste bag must hang over the base. Such an arrangement is unsightly.

The present invention remedies these deficiencies and discloses various universal shredder waste bags, housing configurations, and attachment mechanisms which allow a shredder bag to secure to a shredder.

One preferred embodiment of the claimed invention provides this by incorporating an adhesive on the upper part of the shredder bag on the inner surface of the bag such that the adhesive can secure to the underside of the shredder housing. Other preferred embodiments include an elastic band or string on the upper part of the shredder bag which can secure to a notch or ridge on the underside of the shredder housing.

Another preferred embodiment of the claimed invention discloses various attachment mechanisms which secure a shredder bag directly to the underside of the shredder housing or to the base. Yet another preferred embodiment discloses coupling mechanisms which secure a bag between the base and housing.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a shredder waste management system.

In one preferred embodiment, a shredder bag has an adhesive placed on the upper part of the shredder bag and on the inner surface around the periphery of the bag such that the adhesive can secure to the underside of the shredder housing. Other preferred embodiments include an elastic band or string running around the periphery of the upper part of the shredder bag. This elastic or string can then be used to secure to a notch or ridge on the underside of the shredder housing.

Other preferred embodiments of the claimed invention disclose various attachment mechanisms which secure a shredder bag directly to the underside of the shredder housing. A clip on the underside of the housing can be used to secure a shredder bag. Instead of a clip, a hole into which a portion of the bag is inserted and secured can be located on the underside of the housing.

In other preferred embodiments, coupling mechanisms are disclosed which secure a bag between the base and housing. Additional embodiments disclose mechanisms which secure the bag directly to the base.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a cross-sectional view of a shredder waste management system embodying features of this invention.

FIG. 2 is an exploded cross-sectional view of a shredder waste management system embodying features of this invention.

FIG. 3 is a cross-sectional view of a shredder waste management system embodying features of this invention.

FIG. 4 is cross-sectional view of a shredder waste management system embodying features of this invention.

FIG. 5 is a cross-sectional view of a shredder waste management system embodying features of this invention.

FIG. 6 is an exploded cross-sectional view of a shredder waste management system embodying features of this invention.

FIG. 7a is cross-sectional view of a shredder waste management system embodying features of this invention.

FIG. 7b is an exploded view of an attachment mechanism embodying features of this invention.

FIG. 8 is a perspective view of a shredder waste management system embodying features of this invention.

FIG. 9 is a perspective view of a shredder waste management system embodying features of this invention.

FIG. 10 is a perspective view of a shredder waste bag embodying features of this invention.

FIG. 11 is a perspective view of a shredder waste bag embodying features of this invention.

FIG. 12 is a perspective view of a shredder waste management system embodying features of this invention.

FIG. 13 is a perspective view of a shredder waste management system embodying features of this invention.

FIG. 14 is a perspective view of a shredder waste management system embodying features of this invention.

### DETAILED DESCRIPTION OF THE INVENTION

The essential elements of a shredder are comprised of a housing 1, a shredder mechanism 2 which is located inside the housing 1, and a base 3 which supports the housing and collects the shredded material. The housing 1 has an opening or throat 4 that leads to the shredding mechanism 2. Material to be shredded is then fed through the throat 4 and into the shredding mechanism 2.

This invention discloses various universal shredder waste bags and shredder housing and attachment mechanisms which allow a shredder bag to secure to a shredder.

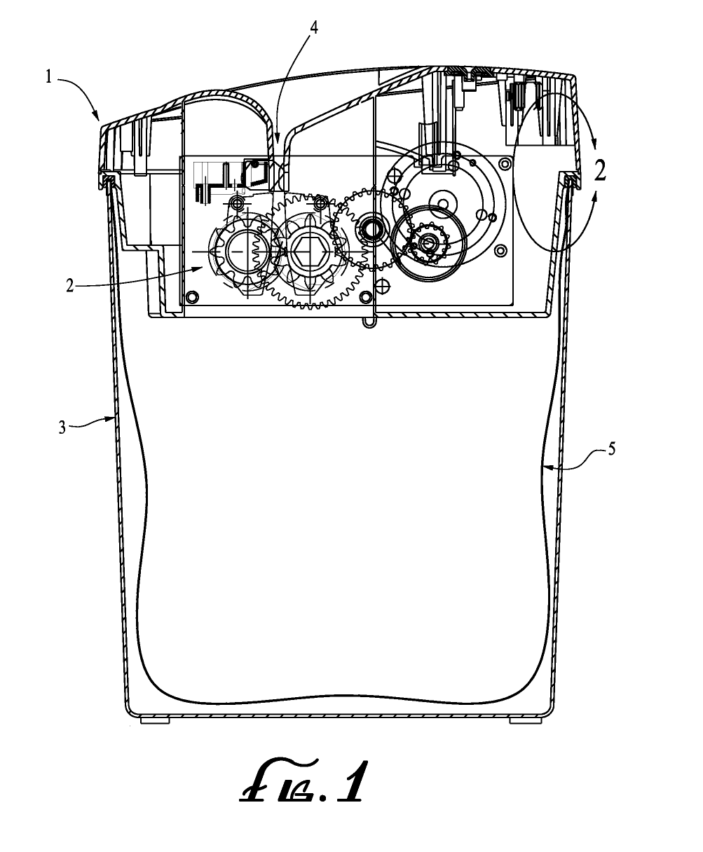

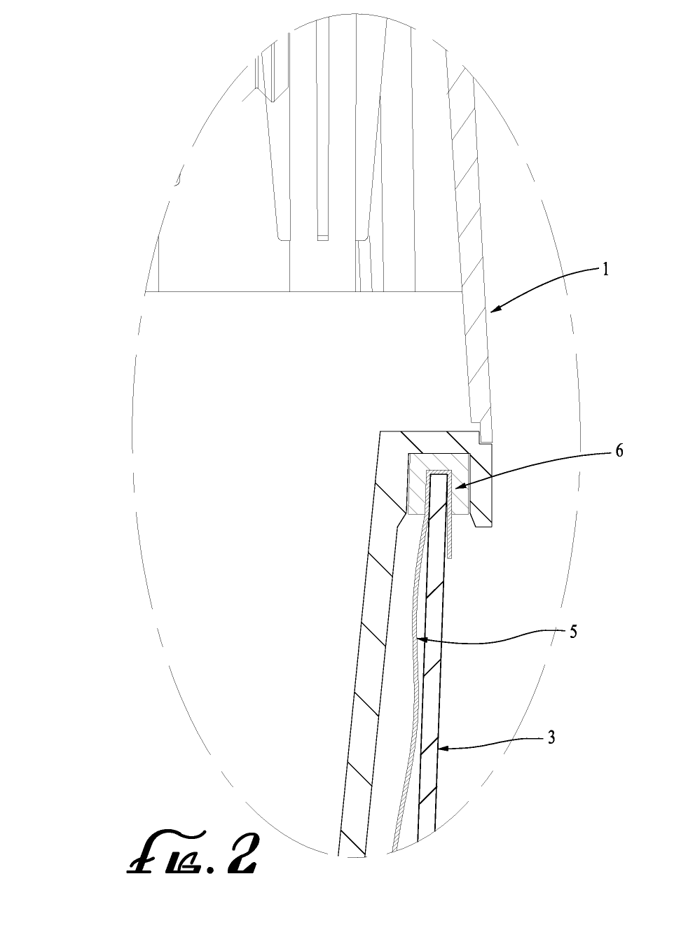

FIGS. 1 and 2 disclose a preferred embodiment whereby the shredder housing 1 and base 3 couple to secure a shredder bag 5. The shredder housing 1 has a female receptacle 6 which receives the base 3 and secures the shredder bag 5 between the housing 1 and the base 3. Preferably the female receptacle 6 runs around the periphery of the housing 1 such that the shredder bag 5 may be secured between the female receptacle 6 and the base 1.

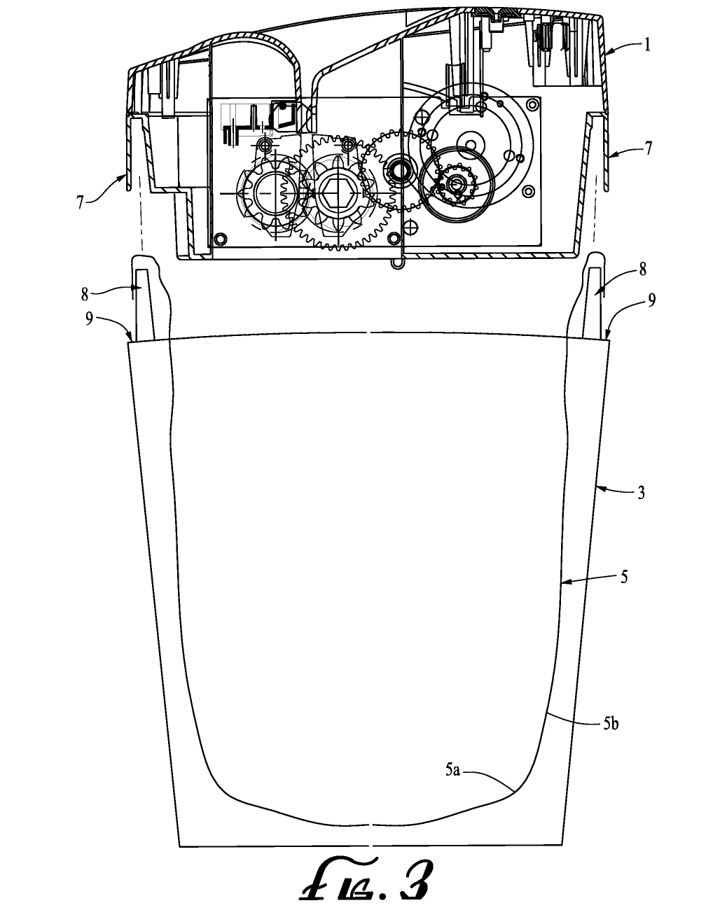

FIG. 3 discloses another preferred embodiment whereby the shredder housing 1 and base 3 couple to secure the shredder bag 5. In this embodiment, the housing 1 has an outer extension 7 around the periphery of the housing 1. The base 3 has an inner extension 8 that runs just inside the periphery of the base 3. Around the periphery of the base 3 and just to the outside of the inner extension 8 is a platform 9 which the housing outer extension 7 rests upon when the housing 1 is placed on the base 3. The shredder bag 5 is secured between the outer extension 7 of the housing 1 and the inner extension 8 of the base 3. Preferably, the width of the platform 9 is equivalent to the width of the housing outer extension 7 such that the two couple relatively seamlessly.

FIG. 4 discloses another preferred embodiment whereby the underside of the housing 1 has at least one clip 10 that secures the shredder bag 5 to the housing 1. There are preferably at least two clips 10 located at approximately opposite sides of the housing 1. It should be appreciated that although this preferred embodiment discloses at least one clip 10, multiple clips 10 may be located at various location on the underside of the housing. Additionally, one long clip 10 could also run along the periphery of the underside of the housing 1.

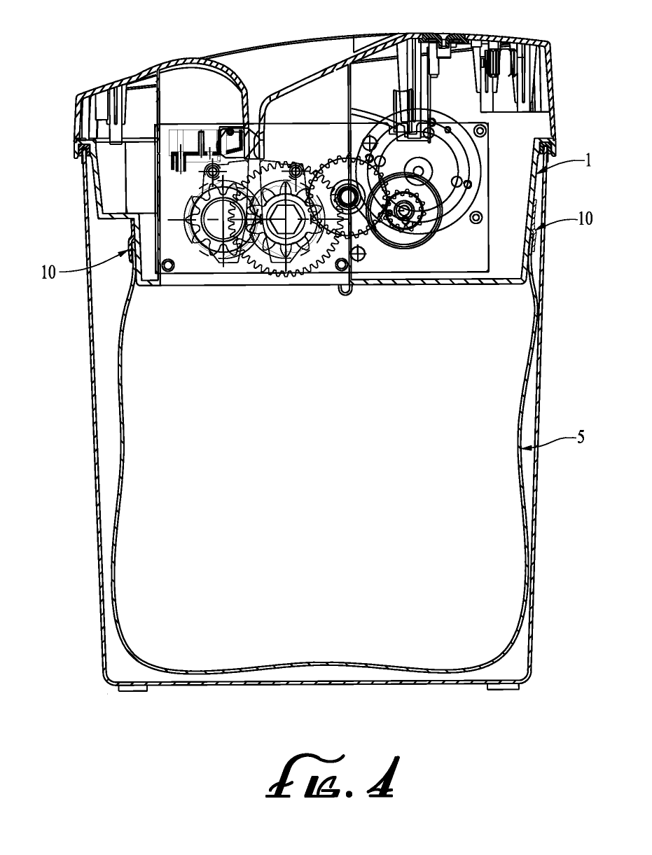

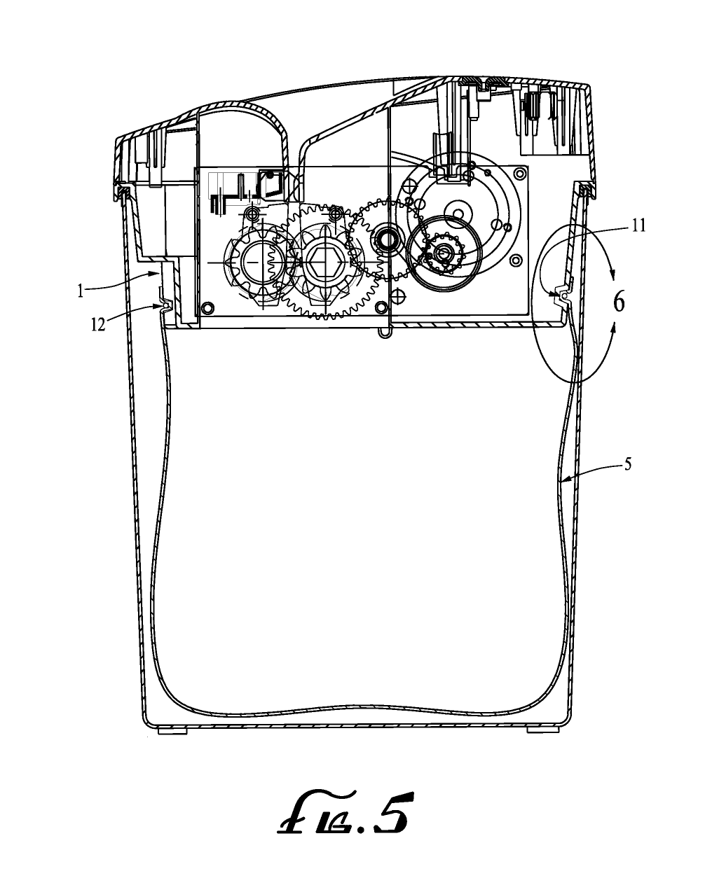

FIGS. 5 and 6 disclose another preferred embodiment whereby the underside of the housing 1 has at least one groove 11 which helps secure the upper portion of the shredder bag 5. As with the clip, it should be appreciated that although this preferred embodiment discloses two grooves 11 on opposite sides, multiple grooves 11 may be located at various location on the underside of the housing 1, or one long groove 11 could run along the periphery of the underside of the housing 1.

To facilitate attachment, a shredder bag is disclosed with an upper portion towards the top opening of the shredder bag and a lower portion towards the bottom closed end of the shredder bag. In addition, the shredder bag has an inner surface 5(a) onto which shredded elements fall, and an outer surface 5(b). See FIG. 3. In order to maximize the amount of shredded material that a shredder bag can hold, the size of the bottom closed end of the shredder bag is preferably at least the same size as the entire bottom of the shredder base. See FIGS. 10 and 11. This is in contrast to traditional disposable bags where the bottom of a bag is simply made by having the sides of a bag join. In these traditional bags, space is wasted, as the bag is unable to fill the entire bottom of the shredder base.

The upper portion of the shredder bag may contain string 12 or elastic that runs around the periphery of the shredder bag 5 which assists in securing the bag into the groove 11. See FIGS. 6, 10 and 11. In yet another preferred embodiment, the shredder bag has at least one adhesive placed on the upper portion of the shredder bag on the inner surface of the bag such that the adhesive can secure to the underside of the shredder housing (not shown). Preferably, two pieces of adhesive can be placed at opposite ends or one long piece of adhesive may run around the periphery of the inner surface of the bag.

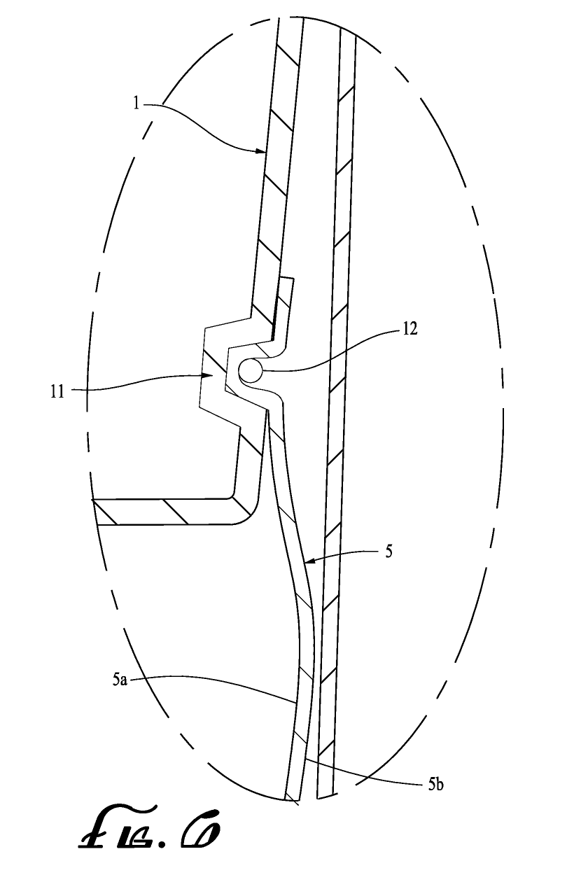

FIGS. 7a and 7b disclose another preferred embodiment whereby the underside of the housing 1 has at least one aperture 13 into which a portion of the shredder bag 5 is placed and thus secured. As seen in FIG. 7b the aperture 13 can have a point or hook 14 which can pierce and assist in securing the shredder bag. Although the preferred embodiment discloses two apertures on opposite sides, multiple apertures may be located at various locations on the underside of the housing.

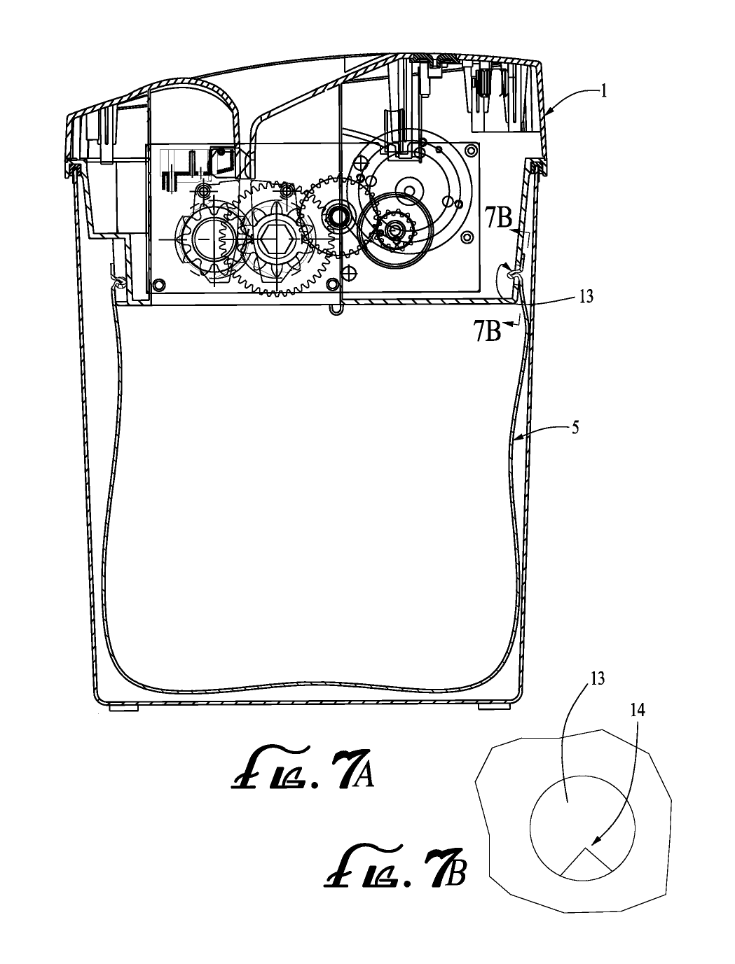

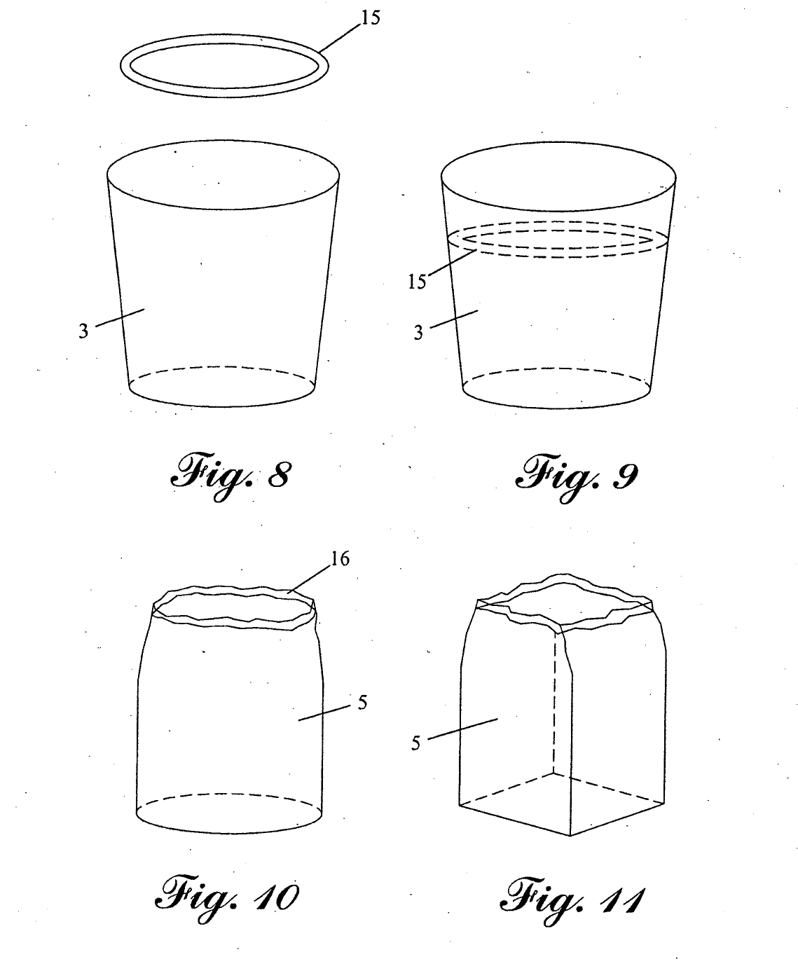

FIGS. 8 and 9 disclose another preferred embodiment whereby a ring 15 is used to secure a shredder bag 5 in a shredder base 3. In this embodiment, a bag 5 is first inserted into the base 3, and then a ring 15 is placed inside the bag 5. The bag 5 is then secured when it is sandwiched between the ring 15 and the base 3. The ring 15 is preferably made of rubber or pliable plastic such that the ring 15 may be bent to fit in various size bases 3. For bases 3 that do not taper, the pliability will allow for a ring 15 that is slightly larger than a base 3, to be twisted or bent, and then inserted into the base 3. The size of the ring 15 is such that it is capable of securing the bag 5 towards the top of the base 3.

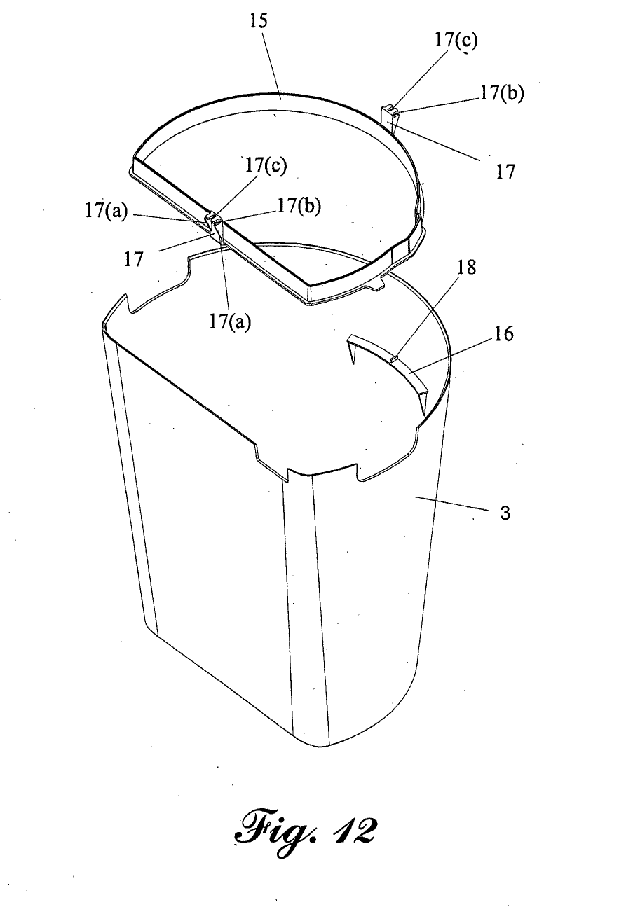

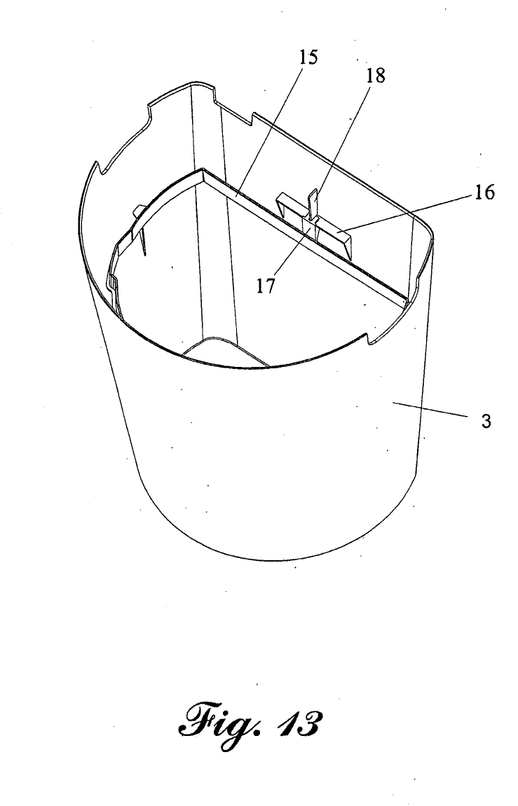

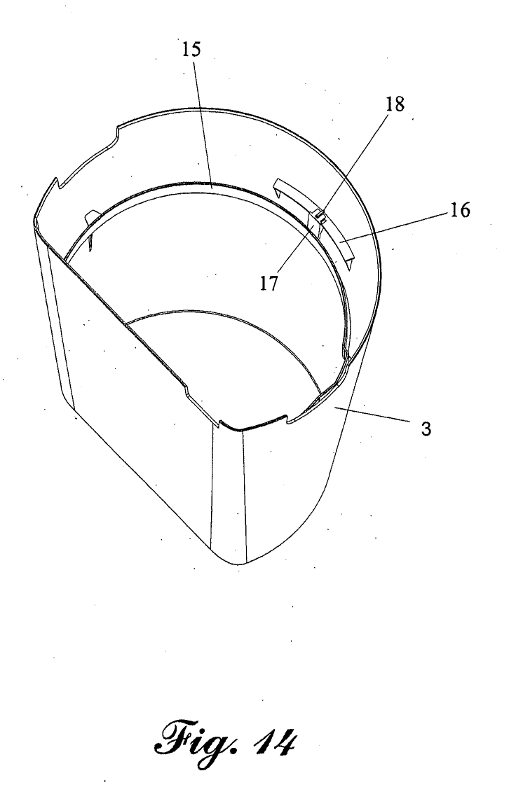

FIGS. 12 through 14 disclose another preferred embodiment wherein a ring 15 secures to a ledge 16 in a base 3. The base 3 preferably has at least two ledges 16, on substantially opposite sides of the base 3 and located towards the top of the base 3. The ring 15 has a connector 17 with an incline 17(a), a horizontal groove 17(b), and vertical groove 17(c). The vertical groove 17(c) couples with a guiding appendage 18 on the ledge 16. In addition, the incline 17(a) along with the horizontal groove 17(b) help secure the ring 15 to the ledge 16 by snapping the ring 15 in place. As in prior ring embodiments, a shredder bag 5 is first placed into the shredder base 3, and then the ring 15 is placed inside the bag 5. The bag 5 is secured to the base 3 when the ring 15 couples with the ledge 16.

It should be appreciated that although this preferred embodiment discloses a ring 15 which couples to two ledges 16 in the base 3, other embodiments may include at least one ledge 16 in the base 3 to which the ring may couple. For example, the ledge 16 may form a ring around the inside of the base 3. In addition, other embodiments do not require a ring to couple with the base. In these embodiments, connectors or clips may attach to the ledge to secure the bag to the base (not shown).

Although the present invention has been described in detail with respect to certain preferred versions thereof, other versions are possible. Therefore, the scope of the claims should not be limited to the description of the preferred versions contained herein.

1. A shredder waste management system comprised of:
(a) a shredder housing;
(b) a shredding mechanism located inside said housing;
(c) a throat through which material to be shredded is fed into said shredding mechanism;
(d) a base; and
(e) a ring which secures a shredder bag to said base.

2. The shredder waste management system of claim 1 wherein said base has at least one ledge upon which said ring can secure said shredder bag to said ledge in said base.

3. A shredder waste management system comprised of:
(a) a shredder housing;
(b) a shredding mechanism located inside said housing;
(c) a throat through which material to be shredded is fed into said shredding mechanism;
(d) a base;
(e) at least one ledge inside said base; and
(f) at least one connectors which can secure a shredder bag to said ledge inside said base.

4. A ring for securing a shredder bag in the base of a shredder; said ring comprised of a pliable material capable of securing a shredder bag towards the top of the base.
